(19) United States
(12) Patent Application Publication
(10) Pub. No.: US 2005/0169806 A1
(43) Pub. Date: Aug. 4, 2005

(54) Air impurity measurement apparatus and method

(76) Inventors: Makiko Katano, Kanagawa (JP); Kazuhiro Nishiki, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/850,163

(22) Filed: May 21, 2004

(30) Foreign Application Priority Data
Jan. 30, 2004 (JP) 2004-22936

(51) Int. Cl. G01N 31/00

(52) U.S. Cl. 422/88; 422/83; 436/148; 436/119

(57) ABSTRACT

According to the present invention, there is provided an air impurity measurement apparatus having, a collector which collects an impurity in the air into pure water; a divider which divides a collecting liquid obtained by said collector into at least two portions; an oxidizer addition unit which adds an oxidizer to at least one of divided collecting liquids obtained by said divider; and an analyzer which analyzes at least one of the collecting liquid to which the oxidizer is added and the collecting liquid to which the oxidizer is not added.

### CROSS REFERENCE TO RELATED APPLICATION

This application is based upon and claims benefit of priority under 35 USC § 119 from the Japanese Patent Application No. 2004-22936, filed on Jan. 30, 2004, the entire contents of which are incorporated herein by reference.

### BACKGROUND OF THE INVENTION

The present invention relates to an air impurity measurement apparatus and method.

As a method of measuring an ionic impurity in the air of, e.g., a clean room in which a semiconductor device fabricating apparatus is installed, a pure water collection ion chromatographic measurement method is conventionally used. In this method, an ionic impurity in the air is collected by dissolving it in pure water by using, e.g., an impinger or diffusion scrubber, and the ionic impurity in this collecting water is analyzed by an analyzer called an ion chromatograph.

A reference related to the conventional air ionic impurity measurement method is as follows.

Japanese Patent Laid-Open No. 8-304363

In this pure water collection ion chromatographic measurement method, SO₄ in the collecting water is measured by assuming that SOₓ in the air is oxidized into SO₄ in the collecting water. However, SO₂ which is SOₓ having the highest ratio is not well oxidized into SO₄ in water, so the measured SOₓ concentration is lower than the actual value.

In addition, a method of collecting the air into collecting water to which H₂O₂ is added beforehand is developed as a manual analysis method. When the air is collected by using this method, the oxidation of SOₓ progresses, and this increases the collection efficiency. However, this method also oxidizes NH₃ and NOₓ in the air, so it is impossible to measure ions other than SOₓ in the same collecting liquid.

### SUMMARY OF THE INVENTION

According to one aspect of the present invention, there is provided an air impurity measurement apparatus comprising:
a collector which collects an impurity in the air into pure water;
a divider which divides a collecting liquid obtained by said collector into at least two portions;
an oxidizer addition unit which adds an oxidizer to at least one of divided collecting liquids obtained by said divider; and
an analyzer which analyzes at least one of the collecting liquid to which the oxidizer is added and the collecting liquid to which the oxidizer is not added.

According to one aspect of the present invention, there is provided an air impurity measurement method comprising:
collecting an impurity in the air into pure water;
dividing an obtained collecting liquid into at least two portions;
adding an oxidizer to at least one of the divided collecting liquids; and
analyzing at least one of the collecting liquid to which the oxidizer is added and the collecting liquid to which the oxidizer is not added.

According to one aspect of the present invention, there is provided an air impurity measurement method comprising:
collecting an impurity in the air into pure water;
dividing an obtained collecting liquid into at least three portions;
leaving at least one of the divided collecting liquids behind, and supplying at least two of the remaining divided collecting liquids to a cation concentrating unit and anion concentrating unit;
adding an oxidizer to said at least one remaining collecting liquid, and supplying the collecting liquid to said anion concentrating unit; and
analyzing each supplied collecting liquid.

### BRIEF DESCRIPTION OF THE DRAWINGS

FIG. 1 is a block diagram showing the arrangement of an air impurity measurement apparatus according to an embodiment of the present invention;

FIG. 2 is a block diagram showing a practical arrangement of the same air impurity measurement apparatus; and

FIG. 3 is a graph showing examples of the efficiency of collection of SO₂ in the air.

### DETAILED DESCRIPTION OF THE INVENTION

An embodiment of the present invention will be described below with reference to the accompanying drawings.

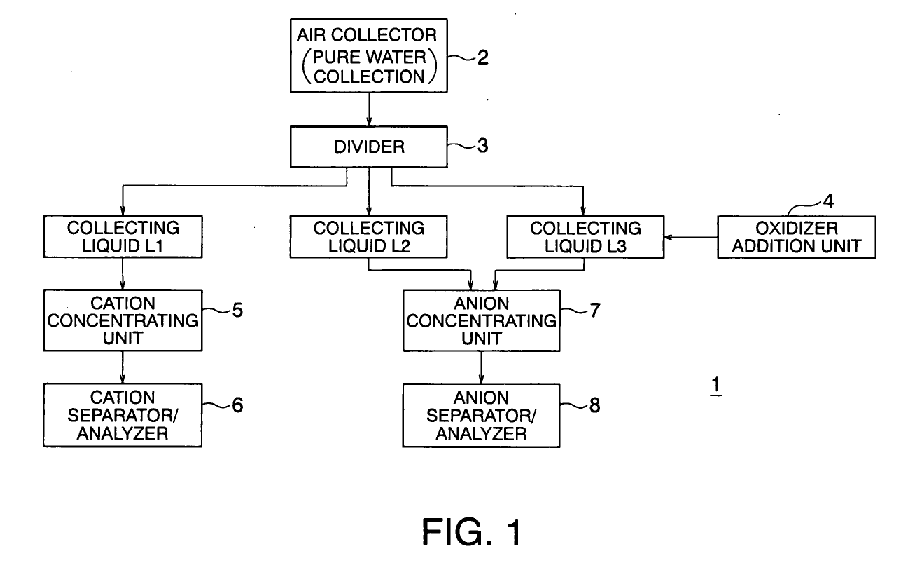

FIG. 1 shows an air impurity measurement apparatus 1 according to the embodiment of the present invention. An air collector 2 collects ionic impurities in the air into pure water by using, e.g., an impinger or diffusion scrubber, and supplies the obtained collecting liquid to a divider 3.

The divider 3 divides the supplied collecting liquid into collecting liquids L1, L2, and L3. An oxidizer addition unit 4 adds an oxidizer only to the collecting liquid L3. The oxidizer addition unit 4 uses, e.g., an aqueous hydrogen peroxide solution or ozone as the oxidizer. It is, however, desirable to add the oxidizer in a minimum amount with which SO₂ is well oxidized into SO₄. When an aqueous hydrogen peroxide solution is to be used as the oxidizer, for example, this oxidizer is preferably added such that the H₂O₂ concentration in the collecting liquid is 0.01 to 0.03 wt %.

The lower limit is 0.01 wt % in order to satisfy the lower-limit concentration necessary to well progress the oxidation of SO₂. The upper limit is 0.03 wt % in order to prevent an increase in measurement background (i.e., a decrease in measurement accuracy) caused by mixing of impurities.

The collecting liquid L1 is then supplied to a cation concentrating unit 5, and undergoes a cation concentrating process in the cation concentrating unit 5. The processed collecting liquid L1 is supplied to a cation separator/analyzer 6. The cation separator/analyzer 6 analyzes cation components such as NH₄ and Na contained in the collecting liquid L1.

On the other hand, the collecting liquid L2 is supplied to an anion concentrating unit 7, and undergoes an anion concentrating process in the anion concentrating unit 7. The processed collecting liquid L2 is supplied to an anion separator/analyzer 8. The anion separator/analyzer 8 analyzes anion components such as F, Cl, NO₂, NO₃, Br, and PO₄ contained in the collecting liquid L2.

After the analysis of the collecting liquid L2 is completed, the collecting liquid L3 to which the oxidizer is added is supplied to the anion concentrating unit 7, and undergoes the anion concentrating process in the anion concentrating unit 7. The processed collecting liquid L3 is supplied to the anion separator/analyzer 8. The anion separator/analyzer 8 analyzes SO₄ contained in the collecting liquid L3 to which the oxidizer is added.

This SO₄ measured by the anion separator/analyzer 8 is the sum of SO₄ obtained by oxidation of SO₂ and SO₃ in the air and SO₄ originally present in the air. Therefore, the total amount of SOₓ in the air is measured.

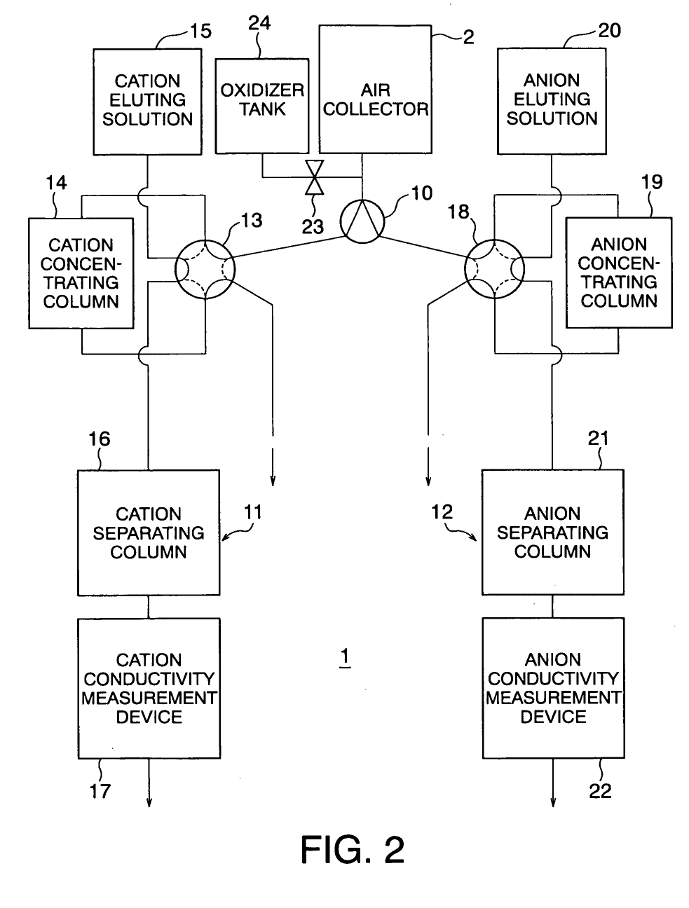

FIG. 2 shows a practical arrangement of the air impurity measurement apparatus 1. The air collector 2 collects ionic impurities in the air by bubbling or the like, and supplies the obtained collecting liquid to a cation measurement system 11 and anion measurement system 12 through a three-way valve 10 of the divider 3.

More specifically, of the obtained collecting liquid, the air collector 2 supplies a collecting liquid L1 weighing ⅓ the total weight to the cation measurement system 11, supplies a collecting liquid L2 weighing ⅓ the total weight to the anion measurement system 12, and leaves a collecting liquid L3 weighing ⅓ the total weight behind.

The collecting liquid L1 supplied to the cation measurement system 11 is supplied to a cation concentrating column 14 of the cation concentrating unit 5 through a six-way valve 13. The cation concentrating column 14 concentrates cation impurities.

After that, the air impurity measurement apparatus 1 switches the six-way valve 13 to supply a cation eluting solution 15 to the cation concentrating column 14, thereby supplying the concentrated cation impurities to a cation separating column 16 and cation conductivity measurement device 17 of the cation separator/analyzer 6. The cation conductivity measurement device 17 measures the cation impurities.

Similarly, the collecting liquid L2 supplied to the anion measurement system 12 is supplied to an anion concentrating column 19 of the anion concentrating unit 7 through a six-way valve 18. The anion concentrating column 19 concentrates anion impurities.

After that, the air impurity measurement apparatus 1 switches the six-way valve 18 to supply an anion eluting solution 20 to the anion concentrating column 19, thereby supplying the concentrated anion impurities to an anion separating column 21 and anion conductivity measurement device 22 of the anion separator/analyzer 8. The anion conductivity measurement device 22 measures the anion impurities.

In addition, after supplying the anion impurities from the anion concentrating column 19 to the anion separating column 21, the air impurity measurement apparatus 1 supplies the collecting liquid L3 remaining in the air collector 2 from the air collector 2 to the anion measurement system 12.

More specifically, the air impurity measurement apparatus 1 opens a valve 23 to add to the collecting liquid L3 an oxidizer stored in an oxidizer tank 24 of the oxidizer addition unit 4. After that, in the same manner as the anion impurity measurement described above, the air impurity measurement apparatus 1 measures SO₄ contained in the collecting liquid L3 to which the oxidizer is added in the anion measurement system 12.

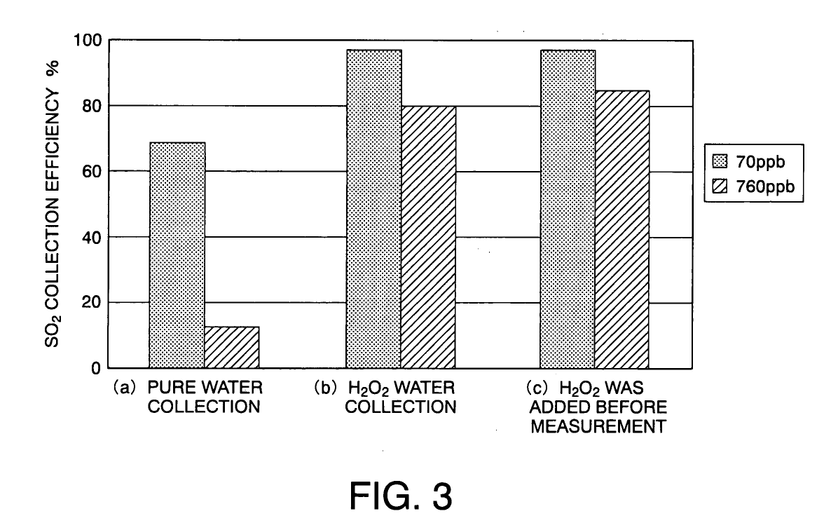

FIG. 3 shows examples of measurements of the efficiency of collection of SO₂ in the air. Referring to FIG. 3, (a) indicates the analysis performed by a pure water collection ion chromatographic measurement method by using the conventional air impurity measurement apparatus. When SO₂ at a concentration of 70 [ppb] in the air was collected, the collection efficiency was about 70%, i.e., insufficient. When the concentration of SO₂ in the air increased (to, e.g., 760 [ppb]), SO₂ was not well oxidized into SO₄, and the collection efficiency further decreased.

On the other hand, (c) indicates the analysis performed by a method of adding H₂O₂ before measurement, in which collection was performed in pure water and H₂O₂ was added before measurement, by using the air impurity measurement apparatus 1 according to the above embodiment. When SO₂ at a concentration of 70 [ppb] in the air was collected, the collection efficiency was about 95% or more.

This collection efficiency was equivalent to that of (b) which indicates the analysis performed by an H₂O₂ water collection method in which the air was collected after H₂O₂ was added to collecting water.

When the concentration of SO₂ in the air increased (to, e.g., 760 [ppb]), SO₂ was not well oxidized into SO₄, and the collection efficiency of any one of (b) and (c) slightly decreased. However, the collection efficiency of (b) and that of (c) are equivalent, and the efficiency of (b) is substantially improved as compared with (a) in which H₂O₂ is not added to collecting water.

In the air impurity measurement apparatus 1 having the above arrangement, ion chromatographic measurement is executed after an oxidizer is added to a collecting liquid obtained by collecting ionic impurities in the air into pure water. Accordingly, the SOₓ concentration in the air can be accurately analyzed.

Also, in the air impurity measurement apparatus 1, a collecting liquid obtained by collecting ionic impurities in the air into pure water is divided, and ion chromatographic measurement is performed after an oxidizer is added only to the collecting liquid L3 for measuring SOₓ. Therefore, ion components (cation components and anion components) other than SOₓ can also be measured by using the same collecting liquid.

In the air impurity measurement apparatus 1 as described above, a collecting liquid obtained by collecting ionic impurities in the air into pure water is divided, and some collecting liquids directly undergo ion chromatographic measurement. After that, an oxidizer is added to the remaining collecting liquid L3, and then the collecting liquid L3 undergoes ion chromatographic measurement. This makes it possible to accurately measure SOₓ and ionic impurities other than the SOₓ by using the same collecting liquid. Therefore, the accuracy of the analysis can be increased by a simple measuring operation.

Note that the air impurity measurement apparatus 1 can also measure the background (i.e., the initial value) of the air impurity measurement apparatus 1 containing an oxidizer and the like, by performing the measurement with no air collection. Accordingly, the air impurity measurement apparatus 1 can perform measurement further accurately by measuring the background beforehand, and subtracting this background from actual measurement performed by air collection.

As described above, the air impurity measurement apparatus and method can accurately analyze impurities including SOₓ by using the same collecting liquid, and can increase the accuracy of the analysis with a simple measuring operation.

In the above embodiment, the measurement of ionic impurities in the air of a clean room in which a semiconductor device fabricating apparatus is installed is described. However, the present invention is not limited to this embodiment. For example, the present invention is also applicable to measurements of various ionic impurities in the air, e.g., measurements of ionic impurities in the atmosphere for the purpose of environmental pollution investigation.

The above embodiment is merely an example and does not limit the present invention. For example, a collecting liquid obtained by the air collector 2 need not be divided into three portions; it need only be divided into at least two portions. More specifically, the collecting liquid is divided into the three collecting liquids L1 to L3 in the arrangement shown in FIG. 1. However, the collecting liquid may also be divided into two collecting liquids, e.g., the collecting liquid L3 to which an oxidizer is to be added and the collecting liquid L1, or the collecting liquids L3 and L2.

1. An air impurity measurement apparatus comprising:
a collector which collects an impurity in the air into pure water;
a divider which divides a collecting liquid obtained by said collector into at least two portions;
an oxidizer addition unit which adds an oxidizer to at least one of divided collecting liquids obtained by said divider; and
an analyzer which analyzes at least one of the collecting liquid to which the oxidizer is added and the collecting liquid to which the oxidizer is not added.

2. An apparatus according to claim 1, wherein the oxidizer is an aqueous hydrogen peroxide solution.

3. An apparatus according to claim 2, wherein said oxidizer addition unit adds the aqueous hydrogen peroxide solution such that a concentration of the hydrogen peroxide in the collecting liquid is 0.01 to 0.03 wt %.

4. An apparatus according to claim 1, wherein the oxidizer is ozone.

5. An apparatus according to claim 1, wherein said analyzer measures a cation impurity contained in the collecting liquid to which the oxidizer is not added.

6. An apparatus according to claim 1, wherein said analyzer measures an anion impurity contained in the collecting liquid to which the oxidizer is not added.

7. An apparatus according to claim 1, wherein said analyzer measures SO₄ contained in the collecting liquid to which the oxidizer is added.

8. An apparatus according to claim 5, further comprising a cation concentrating unit which concentrates a cation impurity contained in the collecting liquid to which the oxidizer is not added.

9. An apparatus according to claim 6, further comprising an anion concentrating unit which concentrates an anion impurity contained in the collecting liquid to which the oxidizer is not added.

10. An air impurity measurement method comprising:
collecting an impurity in the air into pure water;
dividing an obtained collecting liquid into at least two portions;
adding an oxidizer to at least one of the divided collecting liquids; and
analyzing at least one of the collecting liquid to which the oxidizer is added and the collecting liquid to which the oxidizer is not added.

11. A method according to claim 10, wherein an aqueous hydrogen peroxide solution is used as the oxidizer.

12. A method according to claim 11, wherein the aqueous hydrogen peroxide solution is added such that a concentration of the hydrogen peroxide in the collecting liquid is 0.01 to 0.03 wt %.

13. A method according to claim 10, wherein the oxidizer is ozone.

14. A method according to claim 10, wherein when the analysis is performed, a cation impurity contained in the collecting liquid to which the oxidizer is not added is measured.

15. A method according to claim 10, wherein when the analysis is performed, an anion impurity contained in the collecting liquid to which the oxidizer is not added is measured.

16. A method according to claim 10, wherein when the analysis is performed, SO₄ contained in the collecting liquid to which the oxidizer is added is measured.

17. A method according to claim 14, further comprising concentrating a cation impurity contained in the collecting liquid to which the oxidizer is not added.

18. A method according to claim 15, further comprising a step of concentrating an anion impurity contained in the collecting liquid to which the oxidizer is not added.

19. An air impurity measurement method comprising:
collecting an impurity in the air into pure water;
dividing an obtained collecting liquid into at least three portions;
leaving at least one of the divided collecting liquids behind, and supplying at least two of the remaining divided collecting liquids to a cation concentrating unit and anion concentrating unit;
adding an oxidizer to said at least one remaining collecting liquid, and supplying the collecting liquid to said anion concentrating unit; and
analyzing each supplied collecting liquid.

20. A method according to claim 19, wherein an aqueous hydrogen
peroxide solution is used as the oxidizer.
